(19) United States
(12) Patent Application Publication
(10) Pub. No.: US 2009/0224559 A1
(43) Pub. Date: Sep. 10, 2009

(54) DOOR LATCH ASSEMBLY WITH DAMPING MEMBER OF AUTOMOBILE

(75) Inventor: Jung Hoon Park, Yongin-si (KR)

Correspondence Address: MORGAN, LEWIS & BOCKIUS LLP (SF), One Market, Spear Street Tower, Suite 2800, San Francisco, CA, 94105, US

(73) Assignee: Kia Motors Corporation, Seoul (KR)

(21) Appl. No.: 12/184,084

(22) Filed: Jul. 31, 2008

(30) Foreign Application Priority Data
Mar. 5, 2008 (KR) 10-2008-0027261

(51) Int. Cl. E05B 3/00

(52) U.S. Cl. 292/336.3

(57) ABSTRACT

The present invention relates to a door latch assembly with single complex type damper which is provided to a base plate of a door latch of an automobile door to perform damping function to dampen shocks of both a striker and a pawl lever, comprising: a striker damping part which provides damping force in response to the striker at the moment of surface-contacting the striker which is locked to the claw; and a pawl lever damping part which is formed to face downward at a lower end which is integrally formed by being extended from the striker damping part so as to give damping force to the pawl lever which rotates together with the pawl.

### CROSS-REFERENCE TO RELATED APPLICATION

This application claims priority to and the benefit of Korean Patent Application No. 10-2008-0027261 filed in the Korean Intellectual Property Office on Mar. 25, 2008, the entire contents of which are incorporated herein by reference.

### BACKGROUND OF THE INVENTION

(a) Field of the Invention

The present invention relates to a door latch assembly with single complex type damper of an automobile, and more particularly, to a door latch assembly with single complex type damper of an automobile in which a single damping member can perform damping functions for dampening shocks of a pawl and a striker which are provided inside a door latch assembly.

(b) Description of the Related Art

Generally, a door which is able to be opened and closed and divides the inside and the outside of an automobile to protect passengers and to prevent theft is provided in an automobile, and the door is opened and closed by force applied to a door checker at a pillar which forms a side of a vehicle body.

In addition, the door is provided with a door latch which is configured to be coupled to or released from a door striker which is formed to a vehicle body at an opposite side of a portion at which is coupled to a vehicle body by a door checker thereby being opened and closed and at the same time completely closing the door.

In the conventional door latch, a claw is coupled to a front surface of a base plate to be selectively rotatable in an open direction or a close direction around a first hinge, and a pawl which rotates around a second hinge so as to maintain the full latch state of the claw by a return spring is provided below the claw.

In the conventional door latch which is used as described above, a pawl damper for preventing contact noise of the pawl which operates together with opening and closing operations of the door and stops the pawl is provided thereby reducing contact noise (door-closing sound) of the pawl.

Further, in addition to the pawl damper, a striker damper which prevents contact noise between the striker and the claw and has functions for engaging the striker as well as for stopping the striker, i.e, stopping the door is also provided.

However, since the conventional door latch for an automobile includes several damping members such as the pawl damper and the striker damper, manufacturing cost is increased due to the number of the damping member and the manufacturing process, and in particular, since the pawl damper surface-contacts the pawl so that contact noise generates when the pawl returns.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

The present invention has been made in an effort to provide a door latch assembly with single complex type damper of an automobile in which a single damping member can perform damping functions for dampening shocks of both a pawl and a striker which are provided inside a door latch assembly thereby reducing manufacturing cost by decrease of the number of the damping member and manufacturing processes and closing sound of the door can be improved.

An exemplary embodiment of the present invention provides a single complex type damper which is provided to a base plate of a door latch of an automobile door to perform damping function to dampen shocks of both a striker and a pawl lever.

The single complex type damper may be formed to have a shape of “ [symbol] ” having a first damping part and a second damping part which respectively protrude toward directions corresponding to the striker and the pawl lever at an inner surface of the side part and a lower surface of the lower part so as to respectively give damping force to the striker and the pawl lever.

Further a protrusion part having a wave shape may be formed on a bottom surface of the second damping part such that the bottom surface of the second damping part line- or point-contacts a protrusion of the pawl lever.

A protrusion part with an embossed shape may be formed on a bottom surface of the second damping part such that the bottom surface of the second damping part point-contacts a rounded upper end of the pawl lever.

An another exemplary embodiment of the present invention provides the single complex type damper comprising: a striker damping part which provides damping force in response to the striker at the moment of surface-contacting the striker which is locked to the claw; and a pawl lever damping part which is formed to face downward at a lower end which is integrally formed by being extended from the striker damping part so as to give damping force to the pawl lever which rotates together with the pawl.

The single complex type damper formed to have a shape of “ [symbol] ”, may further comprise: a first damping part which respectively protrude toward the striker from inner surface of the striker damping part so as to give damping force to the striker; and a second damping part which protrude toward the pawl lever from lower surface of the pawl lever damping part so as to respectively give damping force to the pawl lever.

A protrusion part having a wave shape may be formed on a bottom surface of the second damping part such that the bottom surface of the second damping part line- or point-contacts a protrusion of the pawl lever.

A protrusion part with an embossed shape may be formed on a bottom surface of the second damping part such that the bottom surface of the second damping part point-contacts a rounded upper end of the pawl lever.

Further the single complex type damper may comprise a notch part formed between the striker damping part and the pawl lever damping part.

In a further exemplary embodiment the present invention includes a damping device for a door latch of an automobile, comprising a single complex type damper which is provided to a base plate of a door latch of an automobile door to perform damping function to dampen shocks of both a striker and a pawl lever, the single complex type damper comprising: a striker damping part which provides damping force in response to impact of the striker, the striker damping part including a first damping part protruding toward the striker from inner surface of the striker damping part; a pawl lever damping part integrally extending from lower portion of the striker damping part to have a shape of “ [symbol] ,” and formed to face downwardly so as to give damping force to the pawl lever which rotates together with the pawl, including a second damping part protruding toward the pawl lever from bottom surface of the pawl lever damping part; and a notch part formed between the striker damping part and the pawl lever damping part so as to prevent cracks.

The protrusion part having a wave shape may be formed on a bottom surface of the second damping part such that the bottom surface of the second damping part line- or point-contacts a protrusion of the pawl lever.

Further the protrusion part with an embossed shape may be formed on a bottom surface of the second damping part such that the bottom surface of the second damping part point-contacts a rounded upper end of the pawl lever.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a drawing showing a door latch assembly with single complex type damper of an automobile according to an embodiment of the present invention;

FIG. 2 and FIG. 3 are drawings showing mount positions of a door latch assembly with single complex type damper of an automobile according to an embodiment of the present invention;

FIG. 4 and FIG. 5 are perspective views of a door latch assembly with single complex type damper of an automobile according to an embodiment of the present invention;

FIG. 6A and FIG. 6B are perspective views of a damping member of a door latch assembly with single complex type damper of an automobile according to an embodiment of the present invention;

FIG. 7 is a drawing showing operating state of a door latch assembly with single complex type damper of an automobile according to an embodiment of the present invention; and

In the figures, reference numbers refer to the same or equivalent parts of the present invention throughout the several figures of the drawing.

<Representative reference numerals>

| | |
|---|---|
| 100: single complex type damper | 110: striker damping part |
| 111: first damping part | 120: pawl lever damping part |
| 121: second damping part | 122, 122′: protrusion part |

### DETAILED DESCRIPTION OF THE EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Exemplary embodiments of the present invention will hereinafter be described in detail with reference to the drawing.

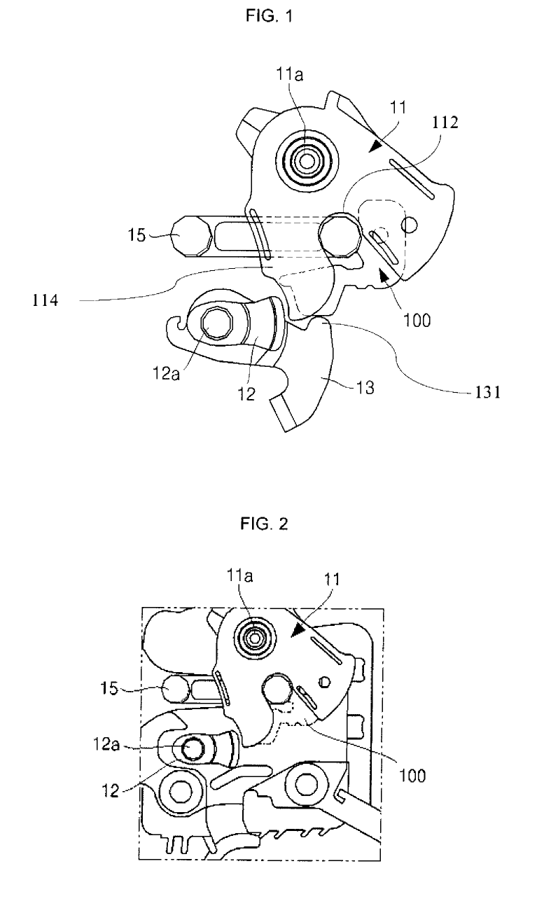

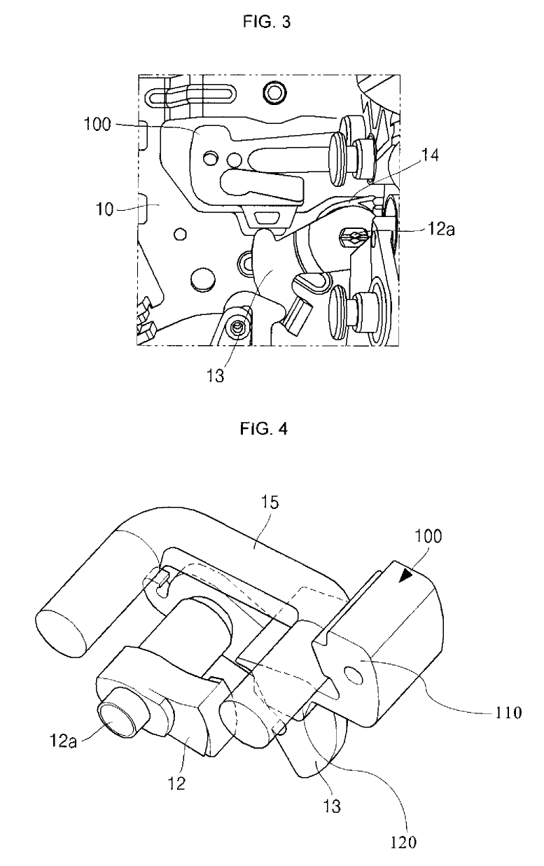

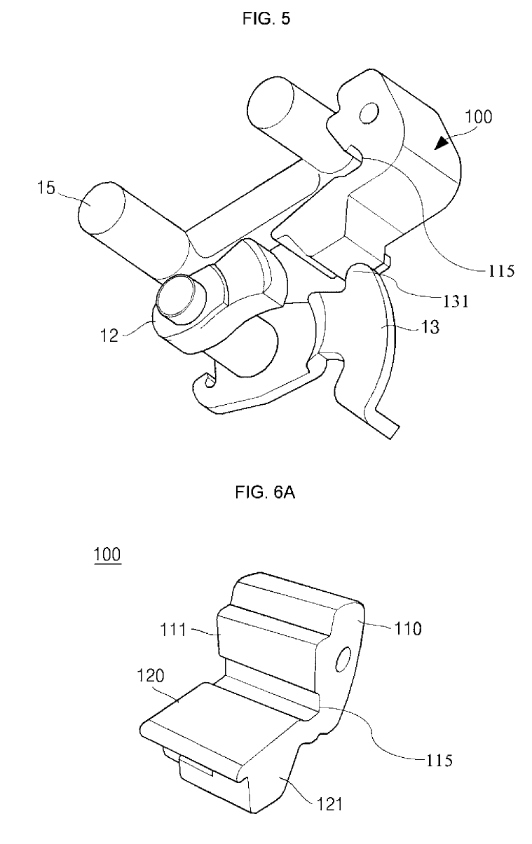

FIG. 1 is a drawing showing a door latch assembly with single complex type damper of an automobile according to an embodiment of the present invention, FIG. 2 and FIG. 3 are drawings showing mount positions of a door latch assembly with single complex type damper of an automobile according to an embodiment of the present invention, and FIG. 4 and FIG. 5 are perspective views of a door latch assembly with single complex type damper of an automobile according to an embodiment of the present invention.

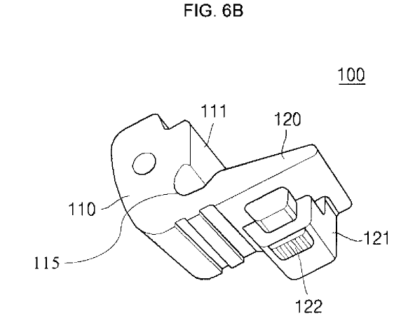

FIG. 6A and FIG. 6B are perspective views of a damping member of a door latch assembly with single complex type damper of an automobile according to an embodiment of the present invention.

Referring to FIG. 1 to FIG. 5, a claw 11 is coupled to a front surface of a base plate 10 of a door latch which is provided to a door of an automobile to be rotatable selectively in an open or close direction around a first hinge 11a, and a pawl which rotates around a second hinge 12a to maintain the latch state of the claw 11 by a return spring 14 is positioned below the claw 11 at a front surface of a base plate 10.

The claw 11 comprises a first claw portion 113, a second claw portion 114, and a locking groove 112 wherein the locking groove 112 is positioned between the first claw portion 113 and the second claw portion 114 to receive one end of a striker 15 as explained later.

In addition, a pawl lever 13 formed at the rear surface of the base plate 10 and positioned co-axially with the second hinge 12a is integrally coupled to the pawl 12 together by rivets so as to rotate together with the rotation of the pawl 12.

The pawl lever 13 comprises a protrusion 131 which protrudes upwards from a distal end portion of the pawl lever 13 substantially in parallel to rotational trajectory of the pawl lever 13. The pawl lever 13 when a door handle is operated in order to release locking of the door, rotates together by rotations of other levers which are formed in a link structure thereby performing function of releasing lock of the claw 11 by the pawl 12.

A single complex type damper 100 is provided at the rear surface of the base plate 10 so as to perform damping function for shocks occurred by impacts of both the pawl lever 13 and the striker 15.

As an exemplary embodiment of the present invention, the single complex type damper 100 includes striker damping part 110, notch part 115, and pawl lever damping part 120.

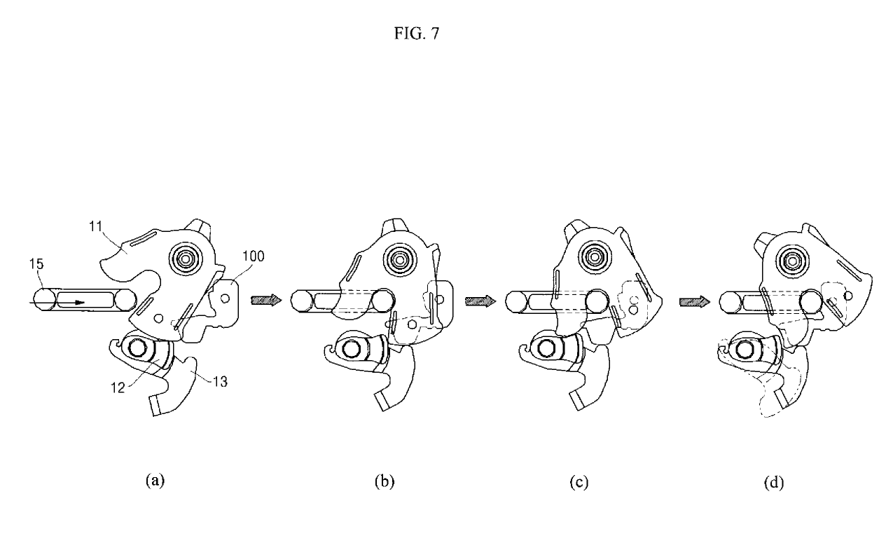

The striker damping part 110 provides damping force in response to impact of the striker 15 at the moment that the striker 15 is locked to the claw 11 in case that the door is closed i.e., when the striker 15 enters into the full latch position (as shown in FIG. 7D) from the half latch position (as shown in FIG. 7C).

The pawl lever damping part 120 extends integrally from lower portion of the striker damper 110 and faces the protrusion 131 of the pawl lever 13 downward at a lower distal end so as to give damping force to the pawl lever 13 which rotates together with the pawl 12.

The notch part 115 is formed between the striker damping part 110 and the pawl lever damping part 120 and prevent cracks which may occur therebetween and thus increases durability of the single complex type damper 100.

The single complex type damper 100, as shown in FIG. 1 is located backward the claw 11 with respect to the first hinge 11a to be fixed to a rear surface of the base plate 10 and is formed to have a shape of “ [symbol] .”

The single complex type damper 100 further includes a first damping part 111 and a second damping part 121 wherein the first damping part 111 protrudes from inner surface of the striker damping part 10 in direction to the striker 15 and the second damping part 121 protrudes in direction to the pawl lever 13 from lower surface of the pawl lever damping part 120 downwardly so as to respectively give damping force to the striker 15 and the pawl lever 13.

Accordingly, the single complex type damper 100 can reduce contact noises and shocks which occur in opening or closing operations of the striker 15 and the pawl 12.

In particular, as shown in FIG. 6B, the second damping part 121 of the pawl lever damping part 120 further includes a protrusion part 122. The protrusion part 122 has a wave shape formed on a bottom surface of the second damping part 121 and thus the protrusion part 122 line-or point-contacts the protrusion 131 of the pawl lever 13.

Accordingly, contact noise can be reduced, compared to the surface-contact between the conventional pawl and the pawl damper.

As an another exemplary embodiment of the structure for the point-contact of the second damping part 121, the wave shape can be replaced with an embossed shape on a bottom surface of the second damping part 121, thereby achieving the point-contact effectively.

Operations of a damping device according to an embodiment of the present invention will be explained hereinafter with reference to the drawings.

FIG. 7 is a drawing illustrating operating state of a door latch assembly with single complex type damper of an automobile according to an embodiment of the present invention.

Firstly, the close locking state of the door will be explained.

The striker 15 is fixed to a vehicle body and elements and the claw 11 and the pawl 12 are mounted to the door for opening or closing operation. However, for convenience of explanations, it will be assumed that the striker 15 moves relatively to the claw 11.

Accordingly, as the door is to be closed, the striker 15 moves into the locking groove 112 of the claw 11 and one side of the striker 15 pushes the first claw portion 113 of claw 11, the pawl 12 and the pawl lever 13 are released downwardly from the claw 11 as shown in FIGS. 7A and 7B.

As the first and second claw portions 113 and 114 pass the pawl 12 in contact with the pawl 12, the pawl 12 and the pawl lever 13 rotate upwardly with respect to the second hinge 12a by the return spring 14, the protrusion 131 of the pawl lever 13 gives impact force to the second damping part 121 of the single complex type damper 100 as shown in FIGS. 7C-7D but the impact is absorbed by the second damping part 121 in line or point contact.

As the second claw portion 114 further moves to the first claw portion 113, the claw 11 further rotates around the first hinge 11a to be in the full latch state, and then the striker 15 gives impact force to the first damping part 11 of the striker damping part 110 of the single complex type damper 100. However, the impact is absorbed by the first damping part 111 and at this time, the pawl 12 and the pawl lever 13 is continuously supported by return force of the returning spring.

Meanwhile, in case that the door is opened by the operation of the door handle, the pawl lever 13 rotates elastically downwardly by the rotation of another lever (not shown) to release the restriction force of the claw 11 and thus the striker 15 and the claw 11 become disengaged so that the door can be opened.

While the door is opened or closed as such, damping between the striker 15, the pawl 12 and the damping member are stably performed so that noise occurring due to the operations of the striker 15 and the pawl 12 can be minimized while the door is being closed.

As described above, according to a damping device for a door latch of an automobile according to the present invention, manufacturing cost can be reduced by decrease of the number of the damping member and manufacturing processes and closing sound of the door can be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A damping device for a door latch of an automobile, comprising a single complex type damper positioned at a base plate of a door latch of an automobile door to perform damping function to dampen shocks of both a striker and a pawl lever.

2. The damping device of claim 1, wherein the single complex type damper is formed to have a shape of “ [symbol] ” having a first damping part and a second damping part which respectively protrude toward directions corresponding to the striker and the pawl lever at an inner surface of the side part and a lower surface of the lower part so as to respectively give damping force to the striker and the pawl lever.

3. The damping device of claim 2, wherein a protrusion part having a wave shape is formed on a bottom surface of the second damping part such that the bottom surface of the second damping part line- or point-contacts a protrusion of the pawl lever.

4. The damping device of claim 2, wherein a protrusion part with an embossed shape is formed on a bottom surface of the second damping part such that the bottom surface of the second damping part point-contacts a rounded upper end of the pawl lever.

5. The damping device of claim 1, wherein the single complex type damper comprises:
a striker damping part which provides damping force in response to the striker at the moment of surface-contacting the striker which is locked to the claw; and
a pawl lever damping part which is formed to face downward at a lower end which is integrally formed by being extended from the striker damping part so as to give damping force to the pawl lever which rotates together with the pawl.

6. The damping device of claim 5, wherein the single complex type damper formed to have a shape of “ [symbol] ”, further comprises:
a first damping part which respectively protrude toward the striker from inner surface of the striker damping part so as to give damping force to the striker; and
a second damping part which protrude toward the pawl lever from lower surface of the pawl lever damping part so as to respectively give damping force to the pawl lever.

7. The damping device of claim 6, wherein a protrusion part having a wave shape is formed on a bottom surface of the second damping part such that the bottom surface of the second damping part line- or point-contacts a protrusion of the pawl lever.

8. The damping device of claim 6, wherein a protrusion part with an embossed shape is formed on a bottom surface of the second damping part such that the bottom surface of the second damping part point-contacts a rounded upper end of the pawl lever.

9. The damping device of claim 6, wherein the single complex type damper further comprises a notch part formed between the striker damping part and the pawl lever damping part.

10. A damping device for a door latch of an automobile, comprising a damping member configured and dimensioned to be disposed on a base plate of a door latch to perform damping function to dampen shocks of both a striker and a pawl lever, the damping member comprising:
a striker damping part which provides damping force in response to impact of the striker, the striker damping part including a first damping part protruding toward the striker from inner surface of the striker damping part;
a pawl lever damping part integrally extending from a lower portion of the striker damping part to have a “ [symbol] ” shape and formed to face downwardly so as to apply damping force to the pawl lever which rotates together with the pawl, including a second damping part protruding toward the pawl lever from bottom surface of the pawl lever damping part; and
a notch part formed between the striker damping part and the pawl lever damping part.

11. The damping device of claim 10, wherein a protrusion part having a wave shape is formed on a bottom surface of the second damping part such that the bottom surface of the second damping part line- or point-contacts a protrusion of the pawl lever.

12. The damping device of claim 11, wherein a protrusion part with an embossed shape is formed on a bottom surface of the second damping part such that the bottom surface of the second damping part point-contacts a rounded upper end of the pawl lever.
